(19) United States
(12) Patent Application Publication
(10) Pub. No.: US 2006/0121917 A1
(43) Pub. Date: Jun. 8, 2006

(54) Method and system for providing location information service of mobile communication system

(75) Inventor: Jae-Ho Shin, Gyeonggi-Do (KR)

Correspondence Address: FLESHNER & KIM, LLP, P.O. BOX 221200, CHANTILLY, VA, 20153, US

(73) Assignee: LG-Nortel Co., Ltd.

(21) Appl. No.: 11/292,104

(22) Filed: Dec. 2, 2005

(30) Foreign Application Priority Data
Dec. 3, 2004 (KR) 101172/2004

(51) Int. Cl. H04Q 7/20

(52) U.S. Cl. 455/456.5

(57) ABSTRACT

A system and method provides location information service in a mobile communication system using a messaging system. When a request for tracking the location of a target is received from a user terminal, an automatic response system (ARS) transmits the request to a client. The client then sends the request to a location server which tracks a location of the target. Tracking may be performed based on a QoS (Quality of Service) requested by a user and a location check period. The location information may then be transmitted to a message service system, and this system may then transmit the location information to the user terminal in message format.

### BACKGROUND OF THE INVENTION

1. Field of the Invention

The present invention generally relates to communication systems, and more particularly to a system and a method for providing a location information service in a mobile communication system.

2. Description of the Related Art

Mobile communication systems are often equipped with a relevant function part for calculating the location of a terminal in a mobile network. This function is provided a location service which transfers location information of the mobile terminal to a certain entity.

FIG. 1 is a view showing an exemplary construction of a mobile communication system providing a location information service. This system includes an LCS (Location Service) client 10 for requesting tracking of the location of a target terminal (e.g., a mobile terminal desired to be tracked for its location), a GMLC (Gateway Mobile Location Center) 20 for tracking the location of the target terminal based on the request from the LCS client, an HLR (Home Location Register) 30 for registering and managing the location of first and second terminals (user equipments: UEs) 70 and 71, an MSC (Mobile Switching Center) 40 for processing a call between the first and second terminals 70 and 71, and Node Bs 60 and 61 for performing wireless communication with the first and second terminals. The system also includes an RNC (Radio Network Controller) 50 connected to the MSC 40 for controlling the Node Bs 60 and 61.

Operation of the mobile communication system of FIG. 1 will now be explained. When a request for tracking the location of the second terminal 71 is generated, the LCS client 10 requests the GMLC 20 to track the location of the second terminal 71. Then, the GMLC obtains information about an MSC where the second terminal belongs through the HLR 30, and transmits a subscriber location information request message to the corresponding MSC 40 based on the obtained information.

The MSC 40 obtains information on a cell where the second terminal 71 (namely, the target terminal) belongs, and transmits it to the GMLC 20. Then, the GMLC 20 transmits location information based on the obtained cell information to the LCS client.

However, this location information service method has problems. For example, in this method, location information is provided based on an ID of a cell or a corresponding sector ID of a cell, where the target terminal belongs. As a result, QoS (Quality of Service) for tracking the location of a user is not satisfied. In addition, a user who wants to track the location of the target terminal cannot easily register or release the location information service.

### BRIEF DESCRIPTION OF THE INVENTION

An object of the invention is to solve at least the above problems and/or disadvantages and to provide at least the advantages described hereinafter

Another object of the present invention is to provide an apparatus and method for providing a location information service in a mobile communication system, which apparatus and method are capable of allowing a user, who wants to track the location of a terminal, to easily register and release the location information service through an ARS (Automatic Response System).

Another object of the present invention is to provide an apparatus and method for providing a location information service in a mobile communication system, which apparatus and method are capable of providing various location information service qualities through a message service.

Another object of the present invention is to provide an apparatus and method for providing a location information service in a mobile communication system, which apparatus and method are capable of providing location information of a location track target at various periods.

Another object of the present invention is to provide an apparatus and method for providing a location information service in a mobile communication system, which apparatus and method are capable of providing location information of a location track target in a multimedia data form.

These and other objects and advantages of the present invention are achieved by providing a system for providing a location information service in a mobile communication system which, in accordance with one embodiment, includes: an ARS (Automatic Response System) for requesting tracking of a location of a location track target according to a request from a user; and a message service system for providing location information obtained according to the request of location tracking.

The system for providing a location information service may further include: a location service client for receiving a request for tracking of a location from the automatic response system; and a location server for performing tracking of a location according to the location tracking request received from the location service client and transmitting obtained location information to the message service system.

In accordance with another embodiment, the present invention provides a method for providing a location information service in a mobile communication system, including: receiving by an automatic response system a request for tracking of a location of a location track target from a user; and transmitting by the automatic response system the received location tracking request to a location service (LCS) client. The method for providing a location information service may further include providing, by a message service system, location information tracked (obtained) according to the location tracking request through a message service. The message service may be a short message service and/or a multimedia message service.

### BRIEF DESCRIPTION OF THE DRAWINGS

FIG. 1 is a diagram showing a mobile communication system for providing a location information service in accordance with the related art.

FIG. 2 is a diagram showing a system for providing a location information service in a mobile communication system in accordance with one embodiment of the present invention.

FIG. 3 shows steps included in a method for providing a location information service in a mobile communication system in accordance with one embodiment of the present invention.

### DETAILED DESCRIPTION OF THE INVENTION

The present invention provides an apparatus and method for tracking the location of a target terminal in a mobile communication system. In accordance with one embodiment, location tracking is requested through an ARS (Automatic Response System) and information obtained on the location of the target in various service qualities is provided to a user terminal through a message service system.

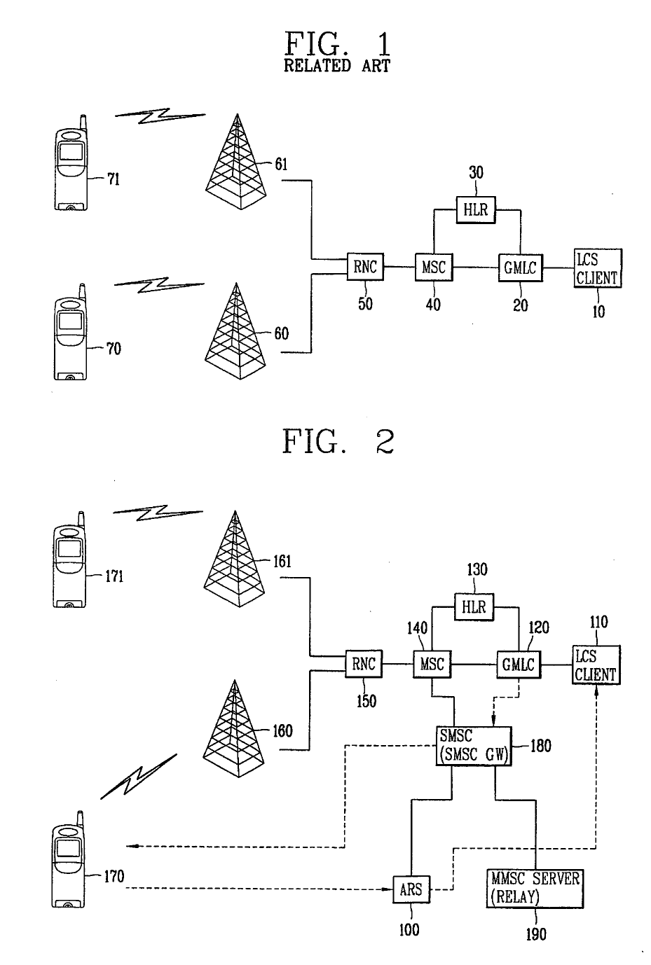

FIG. 2 shows a system for providing a location information service in a mobile communication system in accordance with one embodiment of the present invention. This system includes an ARS 100 for receiving a request from a user terminal to track the location of a target, and for requesting tracking of the location of the target based on the user request. The system further includes at least one and preferably both of message service systems 180 and 190 for providing in message form, obtained location information in respect to the location tracking request.

The target can be a location track-dedicated terminal or a mobile communication terminal having a location tracking service function. Also, the message service system 180 may include an SMSC (Short Message Service Center) for providing the obtained location information to a terminal of the user through a short message. Message service system 190 may include an MMSC (Multimedia Message Service Center) for providing the obtained location information to the terminal of the user through a multimedia message.

In addition to the foregoing features, the system may include a location service (LCS) client 110 for requesting tracking of the location of a location track target based on the location tracking request from the ARS 100, and a location server 120 for tracking the location of the target based on a requested QoS (Quality of Service), according to the request from the LCS client 110.

Additional features includes a location server such as, for example, a GMLC (Gateway Mobile Location Center).

The location information service providing system includes an HLR 130 for registering and managing a location of first and second terminals 170 and 171, an MSC (Mobile Switching Center) 140 for processing a call between first and second terminals 170 and 171, first and second Node Bs 160 and 165 performing wireless communication with the first and second terminals 170 and 171, and an RNC (Radio Network Controller) 150 connected with the MSC 140 for controlling the first and second Node Bs 160 and 165. The first and second terminals may be mobile communication terminals such as handsets, PDAs, or other devices having wireless capabilities.

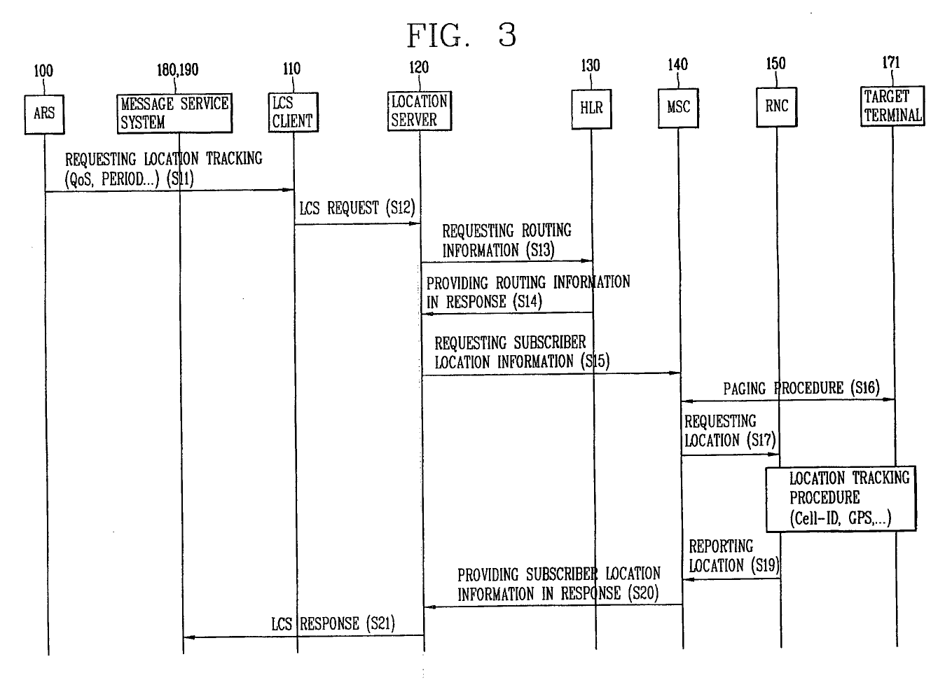

Operation of the system and apparatus for providing location information service in the mobile communication system in accordance with one embodiment of the present invention will now be described. This description is provided with reference to FIG. 3, which illustrates steps included in a method for providing location information service in a mobile communication system in accordance with another embodiment of the present invention.

The first and second terminals 170 and 171 are wirelessly connected to the ARS 100 and may be registered to a location information service, preferably in advance. The first and second terminals may also be connected to the ARS and released from the registered location information service. Thus, the registration and release of the location information service can be easily performed through the ARS.

After the location information service is registered, when a user of the first terminal 170 requests tracking of a location of a location track target (e.g., the second terminal 171), the user of the first terminal is connected to the ARS and requests tracking of the second terminal. When tracking of the location of the second terminal is requested, the user of the first terminal inputs location tracking request-related information based on an announcement of the ARS 100. The location tracking request related information is then transmitted together with the location tracking request from the ARS 100 to the LCS client 110 (step

The location tracking request related information may include information relating to a subscriber of a location track target, information about a subscriber who requests tracking, a location check period, a QoS, or any combination thereof. The information of the subscriber of a location track target can include an MSISDN (Mobile Subscriber ISDN number, e.g., a phone number) of the second terminal 171, and the information on the subscriber who requests tracking includes a MSISDN (e.g., a phone number) of the first terminal 170. The location checking period may be a certain minute period (e.g., five minutes), a certain hour period (e.g., one hour) or a certain day period (e.g., one day). The QoS may include, for example, a cell location information type based on location information of a cell where the location track target belongs and a GPS (Global Positioning System) location information type based on location information of the location track target through a Global Positioning System.

Upon receiving the locating tracking request, the LCS client 110 requests the location server 120 to track a location of the target terminal, namely, the second terminal 171 (step S12). In this case, the location tracking request may be included in information which requests or designates that the location information be provided through a message service.

Here, either the LCS client 110 or the location server 120 may drive a timer based on the location check period information requested by the user. If the LCS client drives the timer, step S12 may be performed based on units of the location check period. If the location server 120 drives the timer, steps S13 and S15 may be performed based on units of the location check period.

Upon receiving the request for tracking the second terminal 171, location server 120 requests routing information to access the second terminal 171 from the HLR (step S13). The routing information may include, for example, an address of the MSC where the second terminal 171 belongs.

The HLR checks a permanent ID (e.g., an international mobile station identity: IMSI) of the second terminal 171 using the MSISDN of the second terminal received from the location server 120, searches a database for an address of the MSC 140 where the second terminal 171 belongs using the permanent ID of the second terminal, and returns a searched address of the MSC 140 to the location server 120 in response to the request for routing information (step S14).

The location server 120 transmits a subscriber location information request message to the MSC 140 to request location information of the second terminal (step S15). The subscriber location information request message may include IMSI information, QoS, etc., of the second terminal 175.

Then, the MSC 140 checks the second terminal through a paging procedure (step S16). When the second terminal 171 transmits a paging response, the MSC transmits a location request message to the RNC 150 where the second terminal belongs (step S17).

The RNC 150 and the second terminal perform a location tracking procedure through a corresponding location tracking method (e.g., a positioning method) (step S18). The corresponding location tracking method may be determined according to the QoS included in the subscriber location information request message.

The RNC 150 uses a location measurement unit (LMU) and a serving mobile location center (SMLC) for performing the location tracking procedure. The location tracking method may include a GPS-based method for checking a location or a method for checking location through OTDOA (Observed Time Difference Of Arrival).

When a current location of the second terminal is tracked through the location tracking procedure, the RNC transmits the current location of the second terminal to the MSC through a location report message (step S19).

Then, the MSC 140 transmits a subscriber location information response message to the location server 120 (step S20). If the location tracking request received in the step S12 instructs a location tracking response through a message service, the location server transmits a location tracking response message (LCS response) to the SMSC 180 to provide the obtained location information of the second terminal to the first terminal through the message service (step S21).

The SMSC 180 may provide the obtained location information of the second terminal to the first terminal through a short message or some other messaging format. The SMSC may include address information of the MMSC 190 in a callback number format, together with the obtained location information of the second terminal in the short message.

When the address information of the MMSC is included in the short message, the first terminal 170 can receive the location information of the second terminal in multimedia data format, for example, by interworking with the MMSC through the address information of the MMSC.

If the multimedia data provided by the MMSC has a media format which may not be accepted by the first terminal, an MMS relay provided in the MMSC may convert the multimedia data into a media format in a file form that the first terminal can receive.

The location server 120 may transmit the location information of the second terminal to the MMSC, and the MMSC may transmit the location information of the second terminal to the first terminal through a multimedia message.

In one particularly advantageous application, the location track target may be a device that can be carried around by a child to prevent the child from becoming missing (e.g., it can be a location tracking-use only terminal or a mobile communication terminal having a location tracking service function). In this case, a user can input a location tracking request including desired QoS information and a desired location checking period through the ARS and receive tracked location information in a multimedia message format, thereby accurately tracking the location of the child or person with the mobile communication terminal.

In another application, the location track target may be a device carried around by a delivery worker. In this case, delivery location information of a product or item to be delivered can be accurately received.

The method and system for providing a location information service of a mobile communication system in accordance with the present invention may therefore have many advantages. For example, first, a user who wants location tracking can easily register and release the location information service through an ARS (Automatic Response System) as necessary.

Second, various types of location information QoS can be provided.

Third, a location information check period of a location track target can be easily changed through the ARS.

Fourth, obtained location information of the location track target can be provided in a multimedia data form.

Fifth, the location of a missing child or a delivery can be periodically provided to a user through a message.

Sixth, a user can request a location tracking service which is differentiated according to accuracy and costs of location tracking through the ARS.

Seventh, a differentiated location tracking service requested by a user can be provided to a terminal of a user in message format.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A system for providing location information service in a mobile communication system, comprising:
an Automatic Response System (ARS) which requests tracking of a location of a target in response to a request from a user; and
a message service system for providing location information of the target to a terminal of the user in response to the request from the ARS.

2. The system of claim 1, wherein the ARS requests a location service client to perform location tracking based on location tracking request related information input by the user.

3. The system of claim 2, wherein the location tracking request related information includes at least subscriber information of the target, information of a subscriber who requests location tracking, a location check period, and a QoS (Quality of Service) of location information.

4. The system of claim 3, wherein each subscriber information includes a MSIDSN (Mobile Subscriber IDSN Number).

5. The system of claim 2, wherein the location service client requests a location server to track a location of the target based on the location tracking request from the ARS.

6. The system of claim 5, wherein the location server transmits the location information of the target to the message service system.

7. The system of claim 5, wherein one of the location service client and the location server drives a timer according to a location check period, and requests location tracking according to the timer.

8. The system of claim 1, wherein the ARS registers a location information service of the user according to a request of the user.

9. The system of claim 9, wherein the ARS releases the location information service of the user according to a request of the user.

10. The system of claim 1, wherein the target is a location tracking-use only terminal.

11. The system of claim 1, wherein the target is a mobile communication terminal having a location tracking service function.

12. The system of claim 1, wherein the message service system includes an SMSC (Short Message Service Center) for providing a short message including the location information to a terminal of the user.

13. The system of claim 1, wherein the message service system includes an MMSC (Multimedia Message Service Center) for providing a multimedia message including the location information to the terminal of the user.

14. A method for providing location information service in a mobile communication system, comprising:
receiving, through an automatic response system (ARS), a request for tracking a location of a target from a user terminal; and
transmitting, from the ARS, the location tracking request to a location service (LCS) client.

15. The method of claim 14, wherein the location tracking request includes at least subscriber information of the target, information of a subscriber who requests location tracking, a location check period, and a QoS (Quality of Service) of location information.

16. The method of claim 15, wherein the subscriber information includes a MSISDN (Mobile Subscriber IDSN Number).

17. The method of claim 15, wherein the location check period information is managed by the LCS client or the location server.

18. The method of claim 14, further comprising:
providing the location information to the user terminal through a message service.

19. The method of claim 18, wherein the message service is a short message service.

20. The method of claim 18, wherein the message service is a multimedia message service.

21. The method of claim 14, wherein the ARS registers a location information service of the user terminal based on a user request.

22. The method of claim 21, wherein the ARS releases the location information service of the user terminal which has been registered, according to a user request.
